(19) United States
(12) Patent Application Publication
(10) Pub. No.: US 2007/0110336 A1
(43) Pub. Date: May 17, 2007

(54) Image processing device and image processing method

(75) Inventor: Kenji Arakawa, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO. LTD., Osaka (JP)

(21) Appl. No.: 10/582,872

(22) PCT Filed: Dec. 14, 2004
(86) PCT No.: PCT/JP04/18626

§ 371 Date: Jun. 14, 2006

(30) Foreign Application Priority Data
Dec. 18, 2003 (JP) 2003-420973

(51) Int. Cl. G06K 9/32

(52) U.S. Cl. 382/294

(57) ABSTRACT

It is facilitated to switch the display image without using map data by linking pieces of image data together by utilizing the position information in the image data.

The following are provided: position information extraction means (2) for extracting position information from image data; position information storage means (3) for storing the extracted position information; position information comparison means (4) for comparing a plurality of pieces of position information stored; comparison reference setting means (5) for setting the comparison reference of the position information in the position information comparison means (4); image reproduction means (6) for reproducing the image data and outputting the reproduction data to a monitor; and reproduction control means (7) for controlling the image reproduced by the image reproduction means (6) based on the result of the comparison by the position information comparison means (4), and by acquiring the correlation between a plurality of pieces of image data from the position information such as the place name, the reproduction data conforming to the condition of the comparison reference such as the distance or direction from the place is outputted.

### TECHNICAL FIELD

The present invention relates to an image processing device and an image processing method capable of reproduction display of image data having position information.

### BACKGROUND ART

Examples of the prior art include one that creates a table containing position data and the like from the position information of image data having position information and displays, on a map, icons corresponding to the latitudes and longitudes in the table. When a desired icon is selected from among the icons displayed on the map, the image taken at the location of the icon is displayed. That is, image data and map data are associated together by position information, and for example, an invention that establishes association with image data having position information has been disclosed (see Patent Document 1).

Patent Document 1: Japanese Laid-Open Patent Application No. 2001-189905

### DISCLOSURE OF INVENTION

### Problem to be Solved by the Invention

To confirm the correlation between pieces of image data by utilizing the position information in the image data, separate map data has conventionally been required. In addition, although the map data and the image data are associated together, since no link is provided between the pieces of image data, switching of the display image is necessarily performed from the map data.

The present invention is made in view of the above-mentioned point, and an object thereof is to provide an image processing device and an image processing method capable of facilitating switching of the display image by associating pieces of image data together.

### MEANS FOR SOLVING THE PROBLEM

To solve the above-mentioned problem, an image processing device of the present invention is an image processing device having image reproduction means for reproducing image data and outputting reproduction data, the image processing device being provided with: position information extraction means for extracting, from image data having position information, the position information; position information storage means for storing the position information extracted by the position information extraction means; position information comparison means for comparing the position information stored in the position information storage means with comparison reference; comparison reference setting means for setting the comparison reference in the position information comparison means; and

reproduction control means for controlling the image reproduction means so as to reproduce image data corresponding to the position information in accordance with a result of the comparison by the position information comparison means.

In the above-described structure, the comparison reference in the comparison reference setting means is the distance from the location represented by the latitude and longitude of the position information.

In the above-described structure, the comparison reference in the comparison reference setting means is the distance from the location represented by the latitude, longitude and altitude of the position information.

In the above-described structure, the comparison reference in the comparison reference setting means is the direction in which the image data is taken.

In the above-described structure, the comparison reference in the comparison reference setting means is the angle.

In the above-described structure, display means, including a liquid crystal monitor, a CRT or a PDP, for displaying the reproduction data outputted from the image reproduction means is provided.

In the above-described structure, superimposition means is provided for superimposing the result of the comparison outputted from the position information comparison means on the reproduction data as at least one of a numeral, a character, an icon and a symbol and outputting it to the display means.

In the above-described structure, the following are further provided: search frame generation means for generating a search frame constituted by at least one of a frame and an icon for specifying an area where the position information is compared within a display area of the reproduction data; and search frame specification means for specifying at least one of the size, color, shape and display position with respect to the reproduction data of the search frame, the superimposition means superimposes the search frame on the reproduction data and outputs it to the display means, and the comparison reference setting means changes the comparison reference set in the position information comparison means in accordance with the size, position and shape of the search frame specified by the search frame specification means.

In the above-described structure, switching means is further provided for instructing the reproduction control means to reproduce selected image data in order to switch the reproduction data, when the image data corresponding to the result of the comparison is within a display area of the reproduction data, the superimposition means superimposes at least one of a numeral, a character, an icon and a symbol in a corresponding position within the display area and displays it.

In the above-described structure, when the reproduction data is switched by the switching means, the image reproduction means simultaneously displays at least one piece of reproduction data corresponding to the comparison result.

In the above-described structure, zoom setting means is further provided for specifying at least one of the zoom magnification and zoom position of the reproduction data, the image reproduction means zooms in or out the reproduction data in accordance with the zoom magnification or zoom position set in the zoom setting means, and the comparison reference setting means changes the comparison reference in accordance with the zoom magnification or the zoom position.

In the above-described structure, the switching means sets the upper limit of the zoom magnification or a zoom step representative of the degree of zooming, and automatically instructs the reproduction control means to reproduce the image data corresponding to the result of the comparison by the position information comparison means when the zoom magnification or the zoom step reaches the set value.

An image processing method of the present invention is an image processing method for reproducing image data and outputting reproduction data, the image processing method being provided with:

a position information extraction step of extracting, from image data having position information, the position information;

a position information storage step of storing the position information extracted at the position information extraction step;

a position information comparison step of comparing the position information stored at the position information storage step with comparison reference;

a comparison reference setting step of setting the comparison reference so as to be used in the position information comparison step; and

a reproduction control step of controlling image reproduction means for outputting the reproduction data, so as to reproduce image data corresponding to the position information in accordance with a result of the comparison at the position information comparison step.

In the above-described structure, the comparison reference is the distance from the location represented by the latitude and longitude of the position information.

In the above-described structure, the comparison reference is the distance from the location represented by the latitude, longitude and altitude of the position information.

In the above-described structure, the comparison reference includes information on the direction in which the image data is taken.

In the above-described structure, the comparison reference includes information having a predetermined angle with respect to the direction in which the image data is taken.

In the above-described structure, a display step is further provided of causing display means including a liquid crystal monitor, a CRT or a PDP to display the reproduction data outputted from the image reproduction means.

In the above-described structure, superimposition step is further provided of performing control so that a result of the comparison outputted at the position information comparison step is superimposed on the reproduction data as at least one of a numeral, a character, an icon and a symbol and displayed at the display step.

In the above-described structure, the following are further provided: a search frame generation step of generating a search frame constituted by at least one of a frame and an icon for specifying an area where the position information is compared within a display area of the reproduction data; and

a search frame specification step of specifying at least one of the size, color, shape and display position with respect to the reproduction data of the search frame,

control is performed so that the search frame is superimposed on the reproduction data at the superimposition step and displayed at the display step, and

at the comparison reference setting step, the comparison reference set at the position information comparison step is changed in accordance with the size, position and shape of the search frame specified at the search frame specification step.

In the above-described structure, a switching step is further provided of providing an instruction to reproduce image data selected at the reproduction control step in order to switch the reproduction data,

when the image data corresponding to the result of the comparison is within a display area of the reproduction data, at the superimposition step, at least one of a numeral, a character, an icon and a symbol is superimposed in a corresponding position within the display area and displayed by the display means.

In the above-described structure, when the reproduction data is switched at the switching step, the image reproduction means simultaneously reproduces at least two pieces of reproduction data corresponding to the result of the comparison, and the at least two pieces of reproduction data are simultaneously displayed at the display step.

In the above-described structure, a zoom setting step is further provided of specifying at least one of a zoom magnification and zoom position of the reproduction data, the image reproduction means zooms in or out the reproduction data in accordance with the zoom magnification or zoom position set at the zoom setting step, and at the comparison reference setting step, the comparison reference is changed in accordance with the zoom magnification or the zoom position.

In the above-described structure, at the switching step, an instruction to reproduce the image data corresponding to the result of the comparison is provided for the reproduction control step in accordance with the zoom magnification or a zoom step representative of a degree of zooming.

### EFFECTS OF THE INVENTION

According to the image processing device and the image processing method of the invention, the correlation between a plurality of pieces of image data can be acquired from the position information such as the place name, and the reproduction data conforming to the condition of the comparison reference such as the distance from the position of the image data as the reference or the zone can be outputted. Consequently, the correlation between the pieces of image data can be confirmed by use of the position information in the image data without the use of map data, and the switching to the relevant display information from the display image and the confirmation of the presence or absence of the image data corresponding to the comparison result can be performed.

Moreover, when the correlation is obtained from more detailed position information of a latitude and a longitude, by setting the distance from the latitude and longitude of the image data as the reference, another piece of image data within a two-dimensional area the center of which is the position of the image data as the reference is detected, and the reproduction data conforming to the condition of the comparison reference from the location and more relevant to the image as the reference can be outputted.

When the correlation is obtained from more detailed position information of a latitude, a longitude and an altitude, by setting the distance from the latitude, longitude and altitude of the image data as the reference, another piece of image data within a three-dimensional area the center of which is the position of the image data as the reference is detected, and the reproduction data conforming to the condition of the comparison reference from the location and more relevant to the image as the reference can be outputted.

In the above, by setting the image data as the reference within the zone in the direction of photographing, another piece of image data contained in the reproduction data as the reference or another piece of image data containing the location where the image data as the reference is taken is easily detected, and the reproduction data conforming to the condition of the comparison reference from the location and more relevant to the image as the reference can be outputted.

In the above, by setting the angle as well as the condition of the comparison reference such as the latitude, the longitude and the altitude or the direction with respect to the position of the currently displayed image data, another piece of image data can be detected within a more limited area within the two-dimensional area or the three-dimensional area, another piece of image data contained in the reproduction data as the reference or another piece of image data containing the location where the currently displayed image data is taken is easily detected, and the reproduction data conforming to the condition of the comparison reference from the location and more relevant to the image as the reference can be outputted.

In the above, by providing the display device such as a liquid crystal monitor, a CRT, a PDP or the like that displays the reproduction data outputted from the image reproduction means, the image data as the reference is confirmed on the screen, and the degree of correlation can be visually confirmed on the screen when switching to the reproduction data conforming to the condition of the comparison reference is made.

Moreover, by indicating the number of pieces of reproduction data conforming to the condition of the comparison reference from the location of the image data as the reference as at least one of a character, an icon and a symbol, the number of pieces of image data conforming to the condition of the comparison reference can be confirmed, and a desired number of pieces of image data can be obtained by changing the comparison reference.

By providing: the search frame generation means for generating the search frame constituted by at least one of a frame and an icon for specifying an area for the comparison of the position information; the search frame specification means for specifying at least one of the size, color, shape and display position with respect to the reproduction data of the search frame; the superimposition means for superimposing the search frame on the reproduction data and outputting it to the display means; and the comparison reference setting means for changing the effective angle, the altitude or the like as the comparison reference set in the position information comparison means in accordance with the size, position and shape of the search frame specified by the search frame specification means, among the displayed reproduction data, the position information can be compared within a limited area of the search frame, and since the effective angle and the altitude are changed in accordance with the search frame by moving the position of the search frame, another piece of image data contained in the reproduction data as the reference is easily detected, so that the reproduction data conforming to the condition of the comparison reference from the location and more relevant to the image as the reference can be outputted.

In the above, by providing: the superimposition means for displaying at least one of a numeral, a character, an icon and a symbol so as to be superimposed in a corresponding position within the display area when the image data corresponding to the comparison result is within the display area of the reproduction data; and the switching means for instructing the reproduction control means to perform reproduction in order to switch the reproduction data to the image data corresponding to the comparison result, even when a plurality of pieces of image data are present within the display area, the positional relationship therebetween can be found, and by selecting the numeral, the character, the icon or the symbol displayed in the corresponding position, switching is made to the image data corresponding to the selected numeral, character, icon or symbol, and the reproduction data more relevant to the image as the reference can be outputted. That is, by using an icon or a frame, switching of the display image can be facilitated.

In the above, by providing the image reproduction device that simultaneously displays one or more pieces of reproduction data corresponding to the comparison result when the reproduction data is switched by the switching means, even when a plurality of pieces of image data corresponding to the comparison result are present, the reproduction data of the plurality of pieces of image data can be simultaneously confirmed. The image data may be displayed in a plurality of parts at different times.

In the above, by providing: the zoom setting means for specifying the zoom magnification and zoom position of the reproduction data; the image reproduction means for zooming in or out the reproduction data in accordance with the zoom magnification and zoom position set by the zoom setting means; and the comparison reference setting means for changing the comparison reference according to the zoom magnification and the zoom position, part of the reproduction data is zoomed to confirm the details of the reproduction data, and by the comparison reference being changed according to the zoom magnification and the zoom position, another piece of image data having a correlation can be detected within the area of the zoomed reproduction data.

In the above, by providing the switching means for setting the upper limit of the zoom magnification or the zoom step representative of the degree of zooming and automatically instructing the reproduction control means to reproduce the image data corresponding to the result of the comparison when the zoom magnification or the zoom step reaches the set value, when part of the reproduction data is zoomed to confirm the details of the reproduction data, the data being reproduced can be viewed until the set zoom magnification or zoom step is reached, and when switching to the data corresponding to the comparison result is intended, by setting a zoom magnification higher than the set upper limit of the zoom magnification or repeating zooming beyond the set zoom step, switching to the image data corresponding to the comparison result can be made. For example, by displaying images taken at predetermined intervals in the direction of photographing so as to be linked together, still images can be viewed as if they were moving images.

### BRIEF DESCRIPTION OF DRAWINGS

FIG. 1 is a structural view of an image processing device 1 of a first embodiment of the invention.

FIG. 2 is a conceptual view of the position information of image data A′ in the first embodiment.

FIG. 3 is a conceptual view of a case where a plurality of pieces of position information of place names are recorded in the first embodiment.

FIG. 4 is a conceptual view of a case where a plurality of pieces of position information of image data of latitudes and longitudes are recorded in the first embodiment.

FIG. 5 is a conceptual view of a case where a plurality of pieces of position information of image data of latitudes, longitudes and altitudes are recorded in the first embodiment.

FIG. 6 is a conceptual view showing the direction of photographing in FIG. 4 in the first embodiment.

FIG. 7 is a conceptual view of a case where pieces of image data X′, Y′ and Z′ continuously taken in the same direction are reproduced by the image processing device 1 in the first embodiment.

FIG. 8 is a conceptual view showing the direction of photographing and the effective angle in FIG. 4 in the first embodiment.

FIG. 9 is a structural view of an image processing device 1 in which display device 8 is provided in the image processing device 1 of FIG. 1 in the first embodiment.

FIG. 10 is a structural view of an image processing device 1 in which superimposition means 9 is provided in the image processing device 1 of FIG. 9 in the first embodiment.

FIG. 11 is a view of a display image 30 displayed when there are two comparison results in the image processing device 1 of FIG. 10 in the first embodiment.

FIG. 12 is a structural view of an image processing device 1 in which search frame generation means 10, search frame specification means 11 and the superimposition means 9 for superimposing a search frame are provided in the image processing device 1 of FIG. 9 in the first embodiment.

FIG. 13 is a view of the display image 30 displayed in the image processing device 1 of FIG. 12 in the first embodiment.

FIG. 14 is a conceptual view of a case where a plurality of pieces of position information of image data of latitudes and longitudes are recorded in the position information storage means 3 in the image processing device 1 of FIG. 12 in the first embodiment.

FIG. 15 is a view of the display image 30 displayed when the size and position of a search frame 32 of FIG. 13 are changed in the first embodiment.

FIG. 16 is a conceptual view in which the search frame 32 of FIG. 14 is changed in the first embodiment.

FIG. 17 is a structural view of an image processing device 1 of a second embodiment provided with: the superimposition means 9 for displaying an icon or the like so as to be superimposed in a corresponding position within a display area; and switching means 12.

FIG. 18 is a conceptual view showing the positioning of the display image 30 and the search frame 32 with respect to a three-dimensional area represented by a latitude, a longitude and an altitude in the second embodiment.

FIG. 19 is a view of the display image 30 where an icon is displayed by the image processing device 1 of FIG. 17 when the position information of FIG. 18 is recorded in the position information storage means 3 in the second embodiment.

FIG. 20 is a view of the display image 30 where the image data ζ corresponding to the icon 34 in FIG. 19 is reproduced in the second embodiment.

FIG. 21 is a view of the display data 30 displayed when the search frame 32 of FIG. 19 is enlarged in the second embodiment.

FIG. 22 is a view of the display image 30 as a result of reproducing pieces of image data α, Δ and ζ in the second embodiment.

FIG. 23 is a structural view of an image processing device 1 of a third embodiment in which the following are provided in the image processing device 1 of FIG. 17: zoom setting means 13; image reproduction means 6 for performing zooming in and zooming out; and comparison reference setting means 5 for changing the comparison reference according to the zoom magnification and the zoom position.

FIG. 24 is a view of the display image 30 of the image data X′ reproduced by the image processing device 1 of FIG. 23 and the display image 30 where the image data X′ is zoomed in the third embodiment.

FIG. 25 is a conceptual view of the position information recorded in the position information storage means 3 for the image data X′ in FIG. 24 in the third embodiment.

FIG. 26 is a structural view of an image processing device 1 in which the switching means 12 is provided for setting the zoom magnification or the upper limit of the zoom step representative of the degree of zooming and automatically instructing reproduction control means 7 to perform reproduction to the comparison result 31 when the set value is reached in the third embodiment.

FIG. 27 is a conceptual view showing that when zoom reproduction of the pieces of image data X′, Y′ and Z′ is performed by the image processing device 1 of FIG. 26, after zooming is performed to the set zoom step “2,” switching to the image corresponding to the comparison result is made in the third embodiment.

### EXPLANATION OF REFERENCE NUMERALS

1 Image processing device
2 Position information extraction means
3 Position information storage means
4 Position information comparison means
5 Comparison reference setting means
6 Image reproduction means
7 Reproduction control means
8 Display device
9 Superimposition means
10 Search frame generation means
11 Search frame specification means
12 Switching means
13 Zoom setting means
20 Icon corresponding to image data α
21 Icon corresponding to image data ζ
22 Icon corresponding to image data Δ
30 Display image
31 Comparison result
32 Search frame
33 Zoom area

### BEST MODE FOR CARRYING OUT THE INVENTION

Hereinafter, image processing devices and image processing methods according to embodiments of the present invention will be described with reference to the drawings.

### First Embodiment

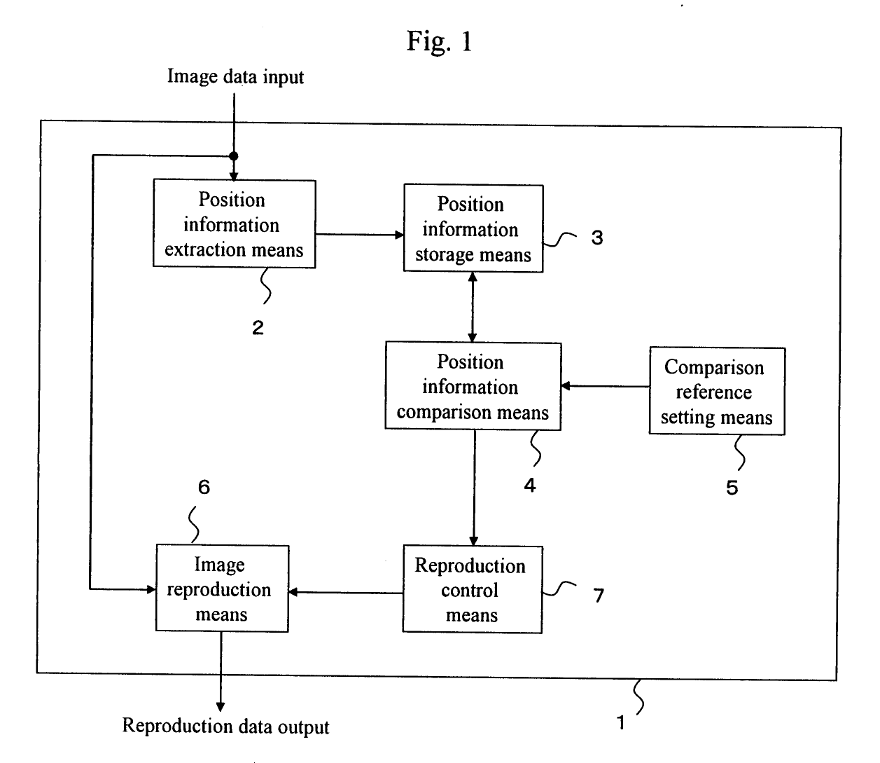

A first embodiment of the invention will be described with reference to FIGS. 1 to 16. As shown in FIG. 1, the image processing device 1 is provided with: position information extraction means 2 for extracting position information from image data having position information; position information storage means 3 for storing the position information extracted by the position information extraction means 2; position information comparison means 4 for comparing a plurality of pieces of position information stored in the position information storage means 3; comparison reference setting means 5 for setting the comparison reference of the position information in the position information comparison means 4; image reproduction means 6 for reproducing the image data and outputting the reproduction data to a display device such as a liquid crystal monitor, a CRT, a PDP or the like; and reproduction control means 7 for controlling the image reproduced by the image reproduction means 6 from the result of the comparison by the position information comparison means 4.

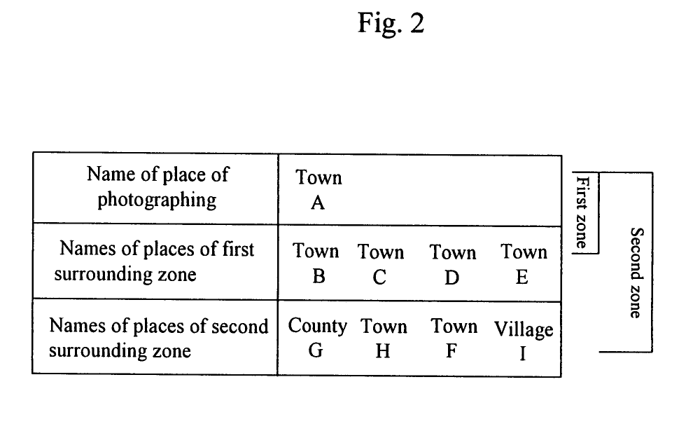

FIG. 2 is a conceptual view of the position information of image data A′ containing the name of the place of photographing and the names of places of surrounding areas. An operation will be shown that is performed when links are made to pieces of image data situated in the first surrounding zone from the image data A′ having the position information in FIG. 2. The position information of the name of the place of photographing and the surrounding places shown in FIG. 2 are extracted by the position information extraction means 2 from the image data A′ inputted to the image processing device 1 of FIG. 1. The position information of the name of the place of photographing and the names of the surrounding places extracted by the position information extraction means 2 are stored in the position information storage means 3. The comparison reference “the first zone from the name of the place of photographing” of the position information is set in the position information comparison means 4 by the comparison reference setting means 5. In this case, as is apparent from FIG. 2, Town B, Town C, Town D and Town E correspond to the first zone from City A which is the name of the place of photographing. When no position information is stored in the position information storage means 3 or when no corresponding image data is present as the result of the comparison of “the first zone from the place of photographing” by the position information comparison means 4, the reproduction control means 7 instructs the image reproduction means 6 to reproduce the image data A′ in response to the result (=no data corresponds) of the comparison by the position information comparison means 4, and the image reproduction means 6 reproduces the image data A′ and outputs the reproduction data to a liquid crystal monitor, a CRT, a PDP or the like.

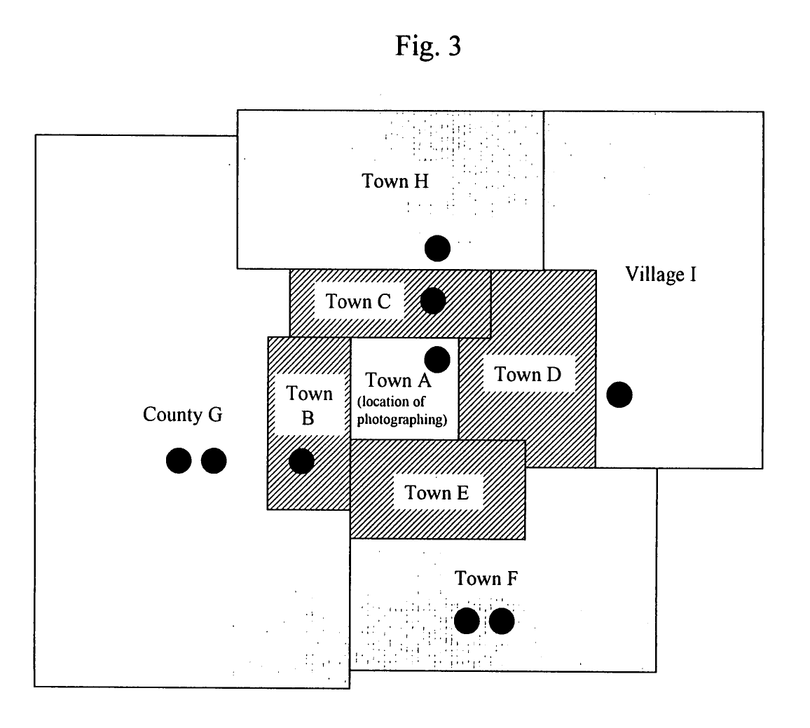

FIG. 3 is a conceptual view of a case where a plurality of pieces of position information of place names of image data are recorded in the position information storage means 3 of FIG. 1. The dots in FIG. 3 represent the number of pieces of image data situated in each place name zone. When the position information in FIG. 3 is previously stored in the position information storage means 3, from the result of the comparison of “the first zone from the place of photographing” by the position information comparison means 4, a total of two pieces of image data, the image data of Town B and the image data of Town C, correspond, the reproduction control means 7 instructs the image reproduction means 6 to successively reproduce the image data of Town B and the image data of Town C in response to the result (=two pieces of data correspond) of the comparison by the position information comparison means 4, and the image reproduction means 6 successively reproduces the image data of Town B and the image data of Town C and outputs the reproduction data to a liquid crystal monitor, a CRT, a PDP or the like.

Next, an operation will be shown that is performed when image data B′ having position information of a latitude and a longitude is linked to another image data having position information of a latitude and a longitude in FIG. 1. The position information of a latitude and a longitude is extracted by the position information extraction means 2 from the image data B′ inputted to the image processing device 1. The position information of a latitude and a longitude extracted by the position information extraction means 2 is stored in the position information storage means 3. The comparison reference “a distance X from the location of photographing” is set in the position information comparison means 4 by the comparison reference setting means 5. When no position information is stored in the position information storage means 3 or when no corresponding image data is present as the result of the comparison of “the distance X from the location of photographing” by the position information comparison means 4, the reproduction control means 7 instructs the image reproduction means 6 to reproduce the image data B′ in response to the result (=no data corresponds) of the comparison by the position information comparison means 4, and the image reproduction means 6 reproduces the image data B′ and outputs the reproduction data to a liquid crystal monitor, a CRT, a PDP or the like.

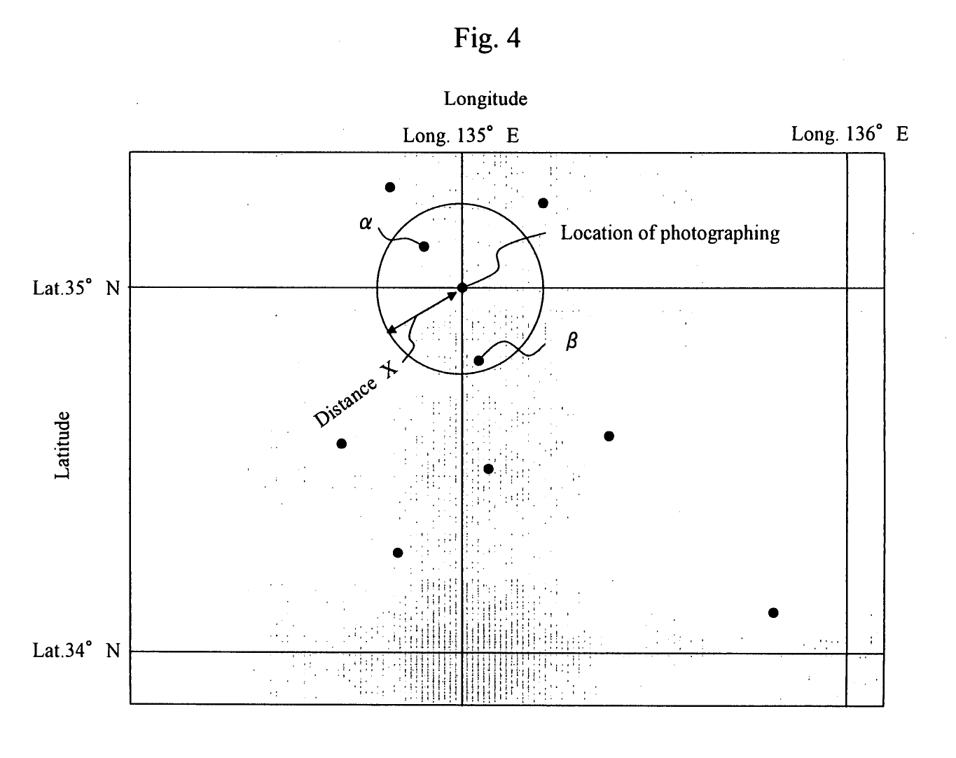

FIG. 4 is a conceptual view of a case where a plurality of pieces of position information of image data of a latitude and a longitude are recorded in the position information storage means 3 of FIG. 1. The dots in FIG. 4 represent the latitude and longitude of the image data B′ having the position information, and the circle with the location of photographing as the center represents the two-dimensional area whose radius is “the distance X from the location of photographing” set in the position information comparison means 4 by the comparison reference setting means 5. The image data having the position information present in the area within the circle shown in FIG. 4 corresponds to the comparison reference; in response to the result (=two pieces of data α and β correspond) of the comparison by the position information comparison means 4, the reproduction control means 7 instructs the image reproduction means 6 to successively reproduce the two pieces of image data α and β in increasing order of distance, and the image reproduction means 6 successively reproduces the two pieces of image data α and β and outputs the reproduction data to a liquid crystal monitor, a CRT, a PDP or the like.

Next, an operation will be shown that is performed when image data C′ having position information of a latitude, a longitude and an altitude is linked to another image data having position information of a latitude, a longitude and an altitude in FIG. 1. The position information of a latitude, a longitude and an altitude is extracted by the position information extraction means 2 from the image data C′ inputted to the image processing device 1. The position information of a latitude, a longitude and an altitude extracted by the position information extraction means 2 is stored in the position information storage means 3. The comparison reference “the distance X from the location of photographing” is set in the position information comparison means 4 by the comparison reference setting means 5. When no position information is stored in the position information storage means 3 or when no corresponding image data is present as the result of the comparison of “the distance X from the location of photographing” by the position information comparison means 4, the reproduction control means 7 instructs the image reproduction means 6 to reproduce the image data C′ in response to the result (=no data corresponds) of the comparison by the position information comparison means 4, and the image reproduction means 6 reproduces the image data C′ and outputs the reproduction data to a liquid crystal monitor, a CRT, a PDP or the like.

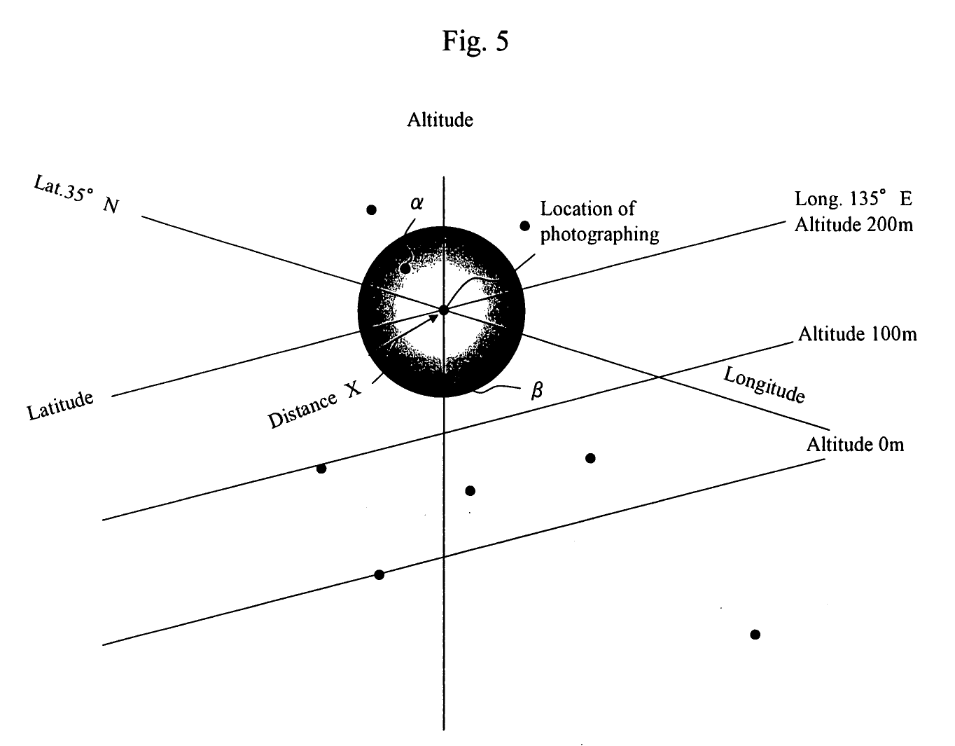

FIG. 5 is a conceptual view of a case where a plurality pieces of position information of image data of a latitude, a longitude and an altitude are recorded in the position information storage means 3 of FIG. 1. The dots in FIG. 5 represent the latitude and longitude of the image data having the position information, and the sphere with the location of photographing as the center represents the three-dimensional area whose radius is “the distance X from the location of photographing” set in the position information comparison means 4 by the comparison reference setting means 5. The image data having the position information present in the area within the sphere shown in FIG. 5 corresponds to the comparison reference; in response to the result (=two pieces of data α and β correspond) of the comparison by the position information comparison means 4, the reproduction control means 7 instructs the image reproduction means 6 to successively reproduce the two pieces of image data α and β in increasing order of distance, and the image reproduction means 6 successively reproduces the two pieces of image data α and β and outputs the reproduction data to a liquid crystal monitor, a CRT, a PDP or the like.

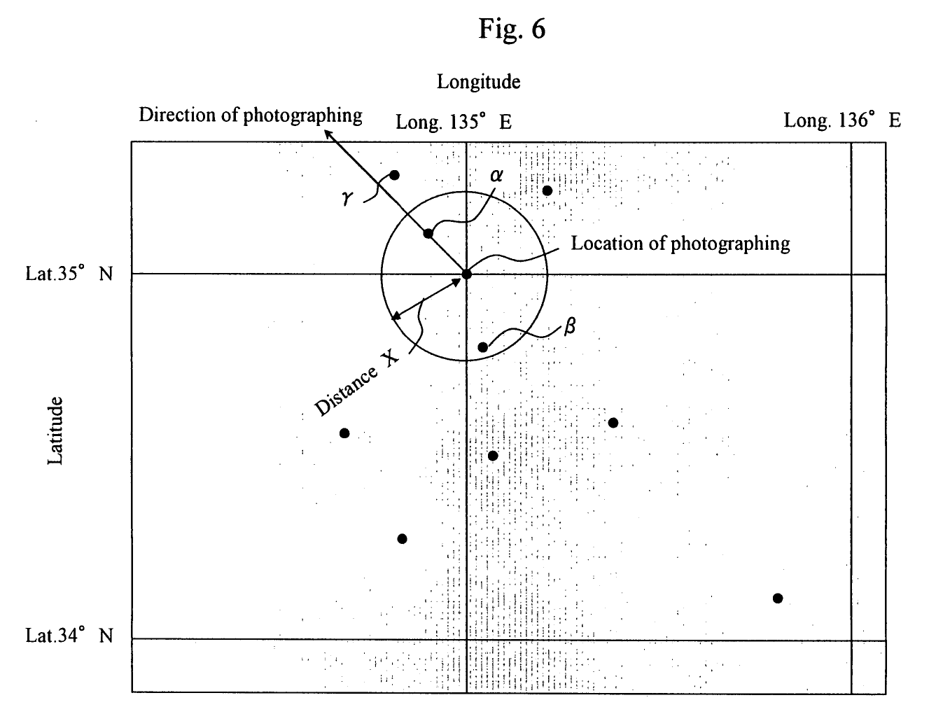

Next, the processing of the image data having the direction of photographing in the position information in FIG. 1 will be shown. The elements other than the position information comparison means 4 and the comparison reference setting means 5 in FIG. 1 are omitted here because they are the same as those described previously. FIG. 6 is a conceptual view showing the direction of photographing in FIG. 4. The direction shown by the arrow from the location of photographing is the direction of photographing. The comparison references “the distance X from the location of photographing” and “the direction of photographing” are set in the position information comparison means 4 by the comparison reference setting means 5. Consequently, the image data corresponding to the distance X from the location of photographing in the direction of photographing is only α, and the image processing device 1 reproduces the image data α.

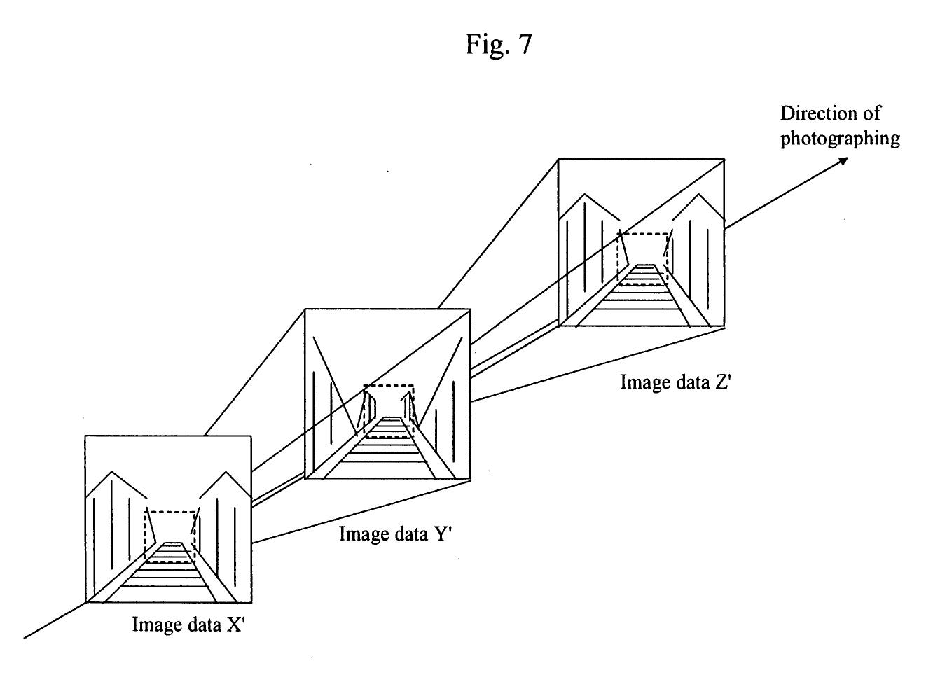

FIG. 7 is a conceptual view of a case where pieces of image data X′, Y′ and Z′ continuously taken in the same direction are reproduced by the image processing device 1. As shown in FIG. 7, the image data Y′ is taken in the direction where the image data X′ is taken, and the image data Z′ is taken in the direction where the image data Y′ is taken. Since they are taken in the same direction, their directions of photographing coincide with one another. When the image processing device 1 is used, even when a plurality of pieces of image data are present in the area whose radius is the distance between the image data X′ and the image data Y′ and the area whose radius is the distance between the image data Y′ and the image data Z′, highly relevant image data can be reproduced according to the condition of the direction of photographing.

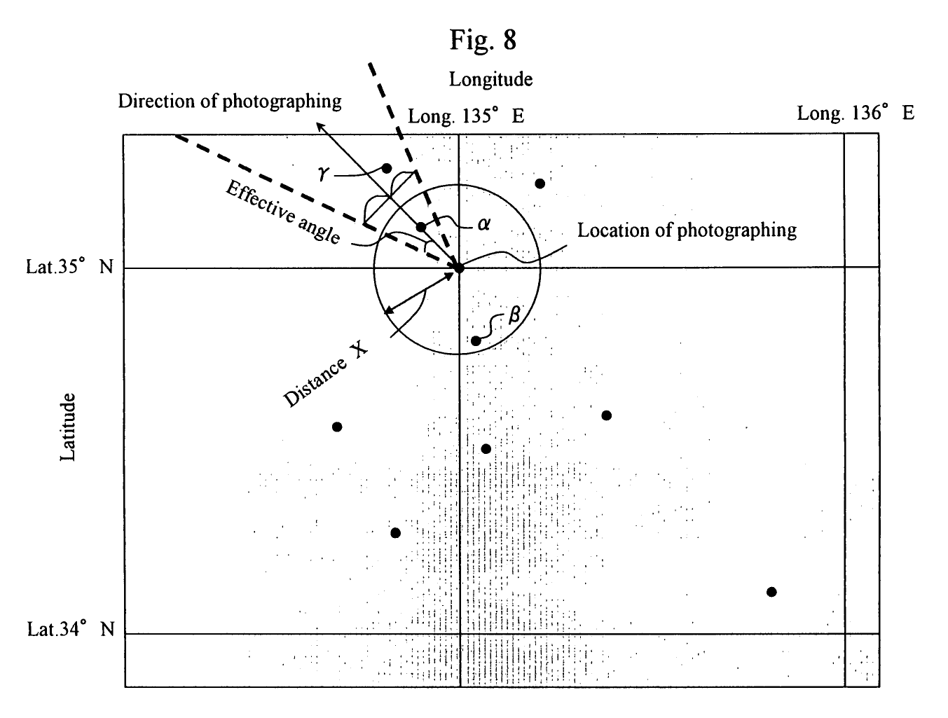

Next, the processing of the image data having the angle of photographing in the position information will be shown. The elements other than the position information comparison means 4 and the comparison reference setting means 5 in FIG. 1 are omitted here because they are the same as those described previously. When the comparison reference “the distance X from the location of photographing” of the position information is set in the position information comparison means 4 by the comparison reference setting means 5 as mentioned previously, the pieces of image data α and β correspond. However, in FIG. 6, when the comparison reference “the direction of photographing” of the position information is also considered, it is not the image data β but image data γ that is more relevant to the image data α. For this reason, when more relevant one is reproduced, the comparison reference “the effective angle in the direction of photographing” is set in the position information comparison means 4 by the comparison reference setting means 5 in addition to the comparison reference “the angle of photographing” of the position information. FIG. 8 is a conceptual view showing the direction of photographing and the effective angle in the direction of photographing in FIG. 4. The area indicated by the thick dashed lines is the position information comparison area sandwiched by the effective angle. In this case, the pieces of image data α and β correspond to the comparison reference, and are reproduced by the image processing device 1. Thereby, the image data taken within an area close to the direction of photographing is reproduced. When the number of corresponding results is too large or when it is intended to more strictly identify the area, the comparison area can be narrowed down by adding “the distance X from the location of photographing” to the comparison reference.

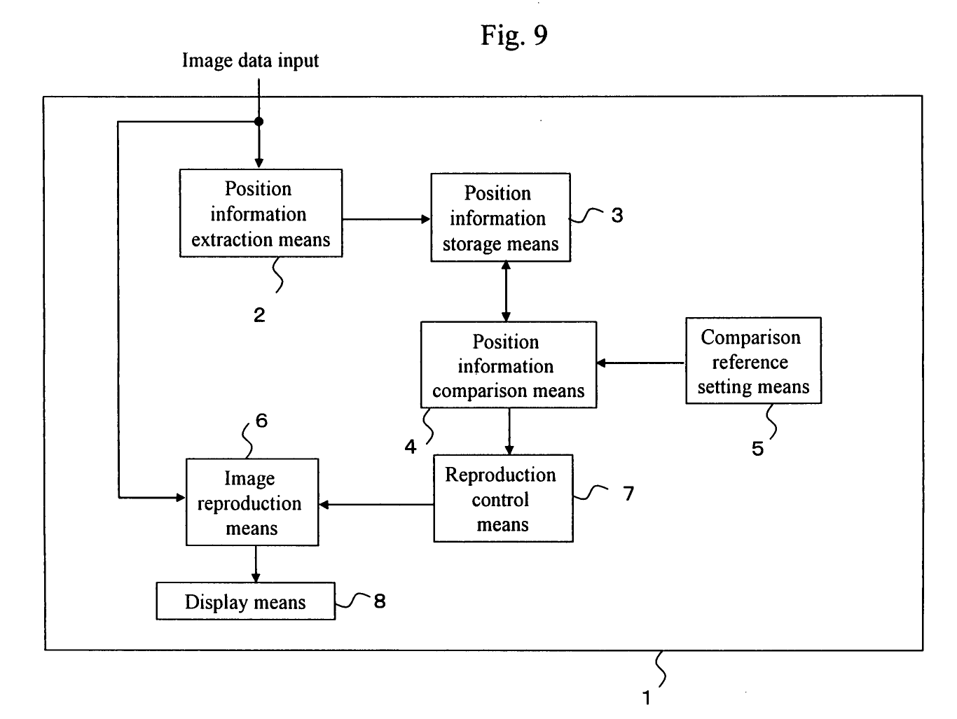

FIG. 9 shows an image processing device 1 in which display means 8 for displaying the reproduction data outputted from the image reproduction means 6 on a liquid crystal monitor, a CRT, a PDP or the like is added to the image processing device 1 of FIG. 1. When the reproduction data outputted from the image reproduction means 6 is switched to the reproduction data conforming to the condition of the comparison reference while the image data serving as the reference is confirmed on the screen by the display means 8, the degree of correlation can be visually confirmed on the screen.

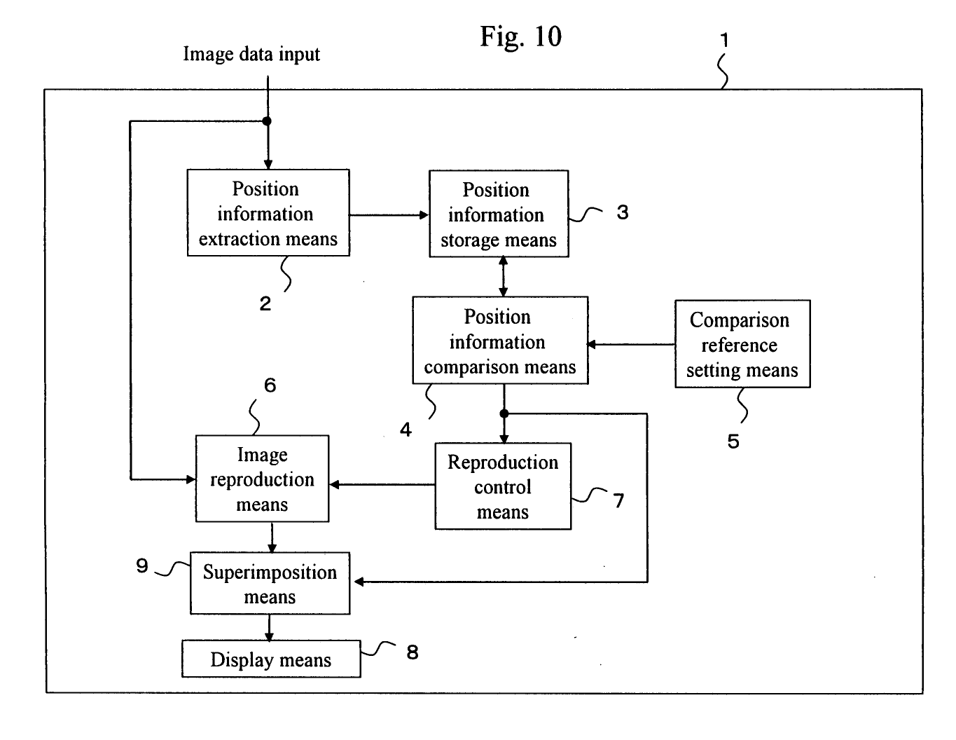

FIG. 10 shows an image processing device 1 in which superimposition means 9 for indicating the comparison result outputted from the position information comparison means 4 as at least one of a numeral, a character, an icon and a symbol, superimposing it on the reproduction data and outputting it to the display means 8 is provided in the image processing device 1 of FIG. 9.

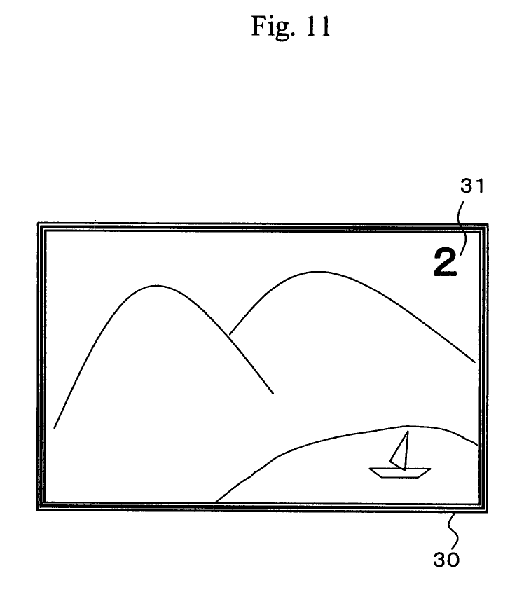

FIG. 11 shows a display image 30, displayed on the display device 8, in which a comparison result 31 is superimposed on the reproduction data by the superimposition means 9 when there are two comparison results in the image processing device 1 of FIG. 10. Together with the reproduction data, a numeral “2” indicative of the comparison result 31 is displayed in the upper right corner of the screen. Since the comparison result can be visually confirmed, the desired comparison result is obtained by changing the comparison reference.

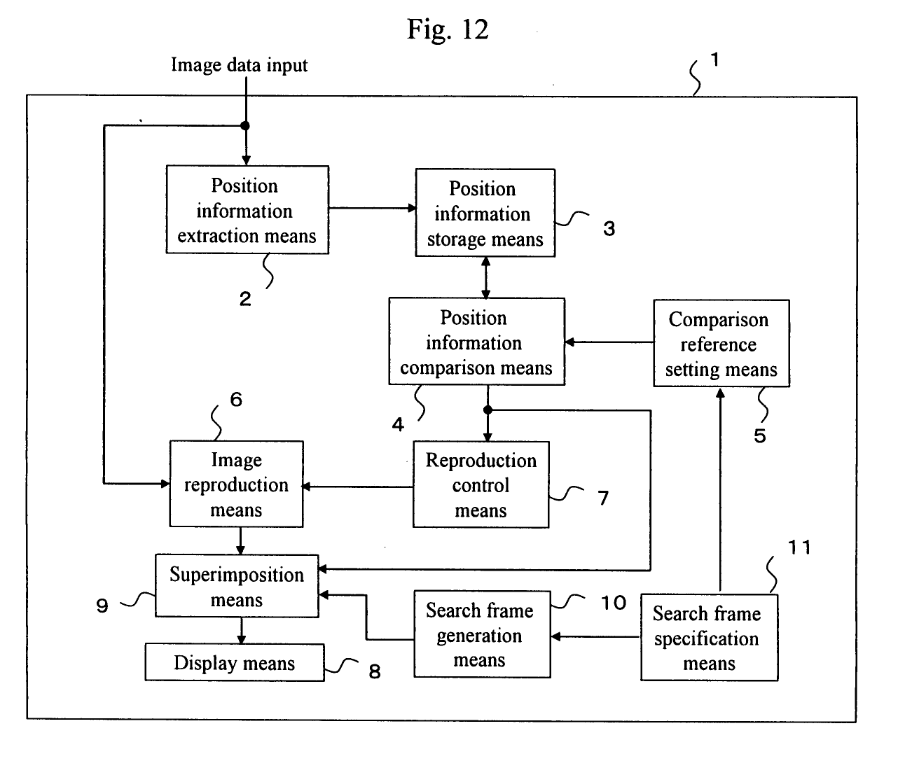

FIG. 12 shows an image processing device 1 in which the following are provided in the image processing device 1 of FIG. 9: search frame generation means 10 for generating a search frame consisting of at least one of a frame for specifying the area for the position information comparison within the reproduction data display area and an icon; search frame specification means 11 for specifying at least one of the size, color, shape and display position with respect to the reproduction data of the search frame; and the superimposition means 9 for superimposing the search frame on the reproduction data and outputting it to the display means. As described in FIG. 10, the superimposition means 9 indicates the comparison result outputted from the position information comparison means 4 as at least one of a numeral, a character, an icon and a symbol, superimposes it on the reproduction data, and outputs it to the display means 8.

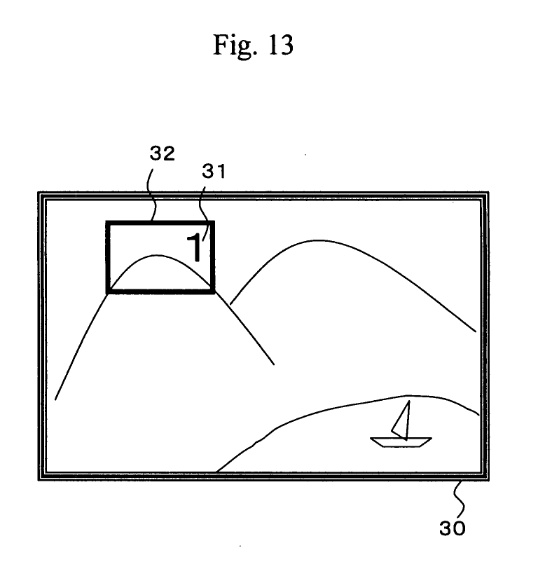

FIG. 13 shows the display image 30, displayed by the display device 8, in which a search frame 32 is generated by the search frame generation means 10 and the search frame specification means 11 and the comparison result 31 and the search frame 32 are superimposed on the reproduction data by the superimposition means 9 in the image processing device 1 of FIG. 12.

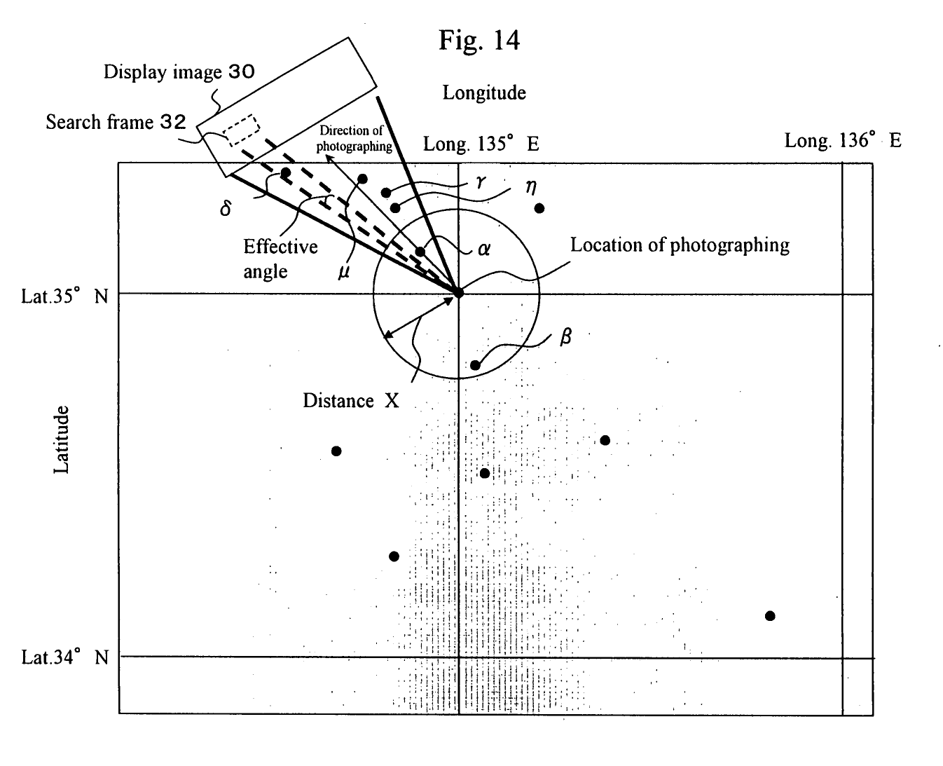

FIG. 14 is a conceptual view of a case where a plurality of pieces of position information of image data of a latitude and a longitude are recorded in the position information storage means 3 in the image processing device 1 of FIG. 12; the image taken area (=the display area of the reproduction data) of FIG. 13 is indicated by the line, and the area within the search frame surrounded by the search frame 32 is indicated by the dashed line.

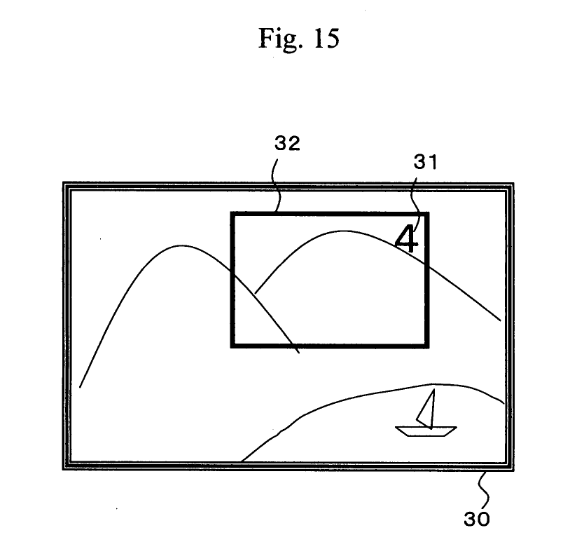

FIG. 15 shows the display image 30 displayed when the size and position of the search frame 32 of FIG. 13 are changed.

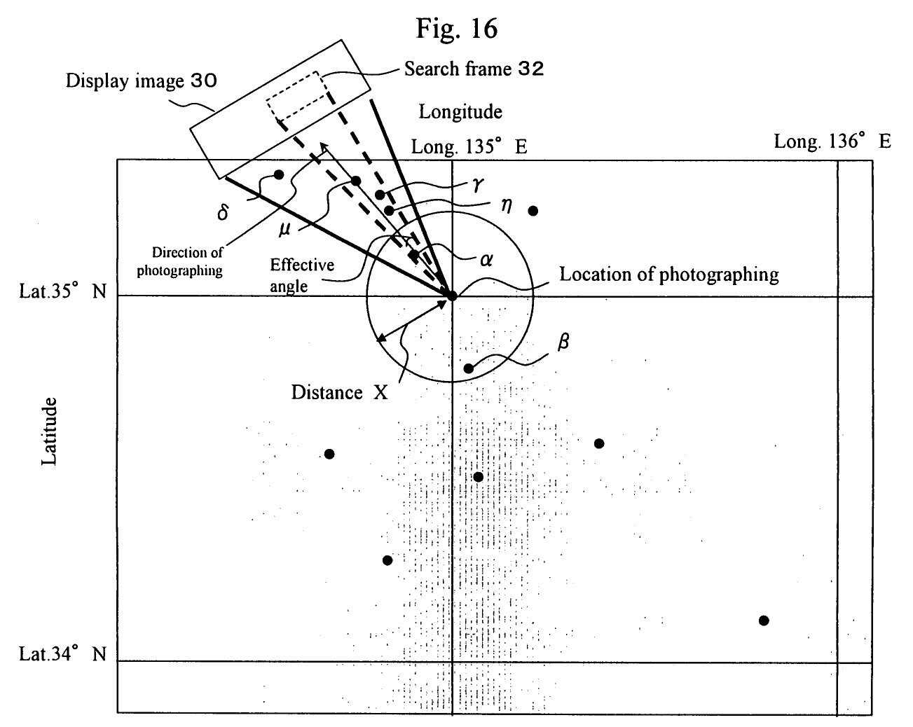

FIG. 16 is a conceptual view in which the search frame 32 of FIG. 14 is changed by the search frame 32 of FIG. 13 being changed. Since one piece of image data δ is present in the area within the search frame in FIG. 13 from FIG. 14, a numeral “1” is displayed as the comparison result 31. In the image processing device 1 of FIG. 12, by changing the size, position and shape of the search frame 32, the effective angle, altitude and the like of the comparison reference set in the position information comparison means 4 by the comparison reference setting means 5 are changed accordingly. That is, when the size and position of the search frame 32 are changed from those of FIG. 13 as shown in FIG. 15, as shown in FIG. 16, the dashed line indicative of the area within the search frame surrounded by the search frame 32 moves from that of FIG. 14, and pieces of image data α, η, γ and μ are present within the area. For this reason, a numeral “4” is displayed as the comparison result 31 in FIG. 15.

### Second Embodiment

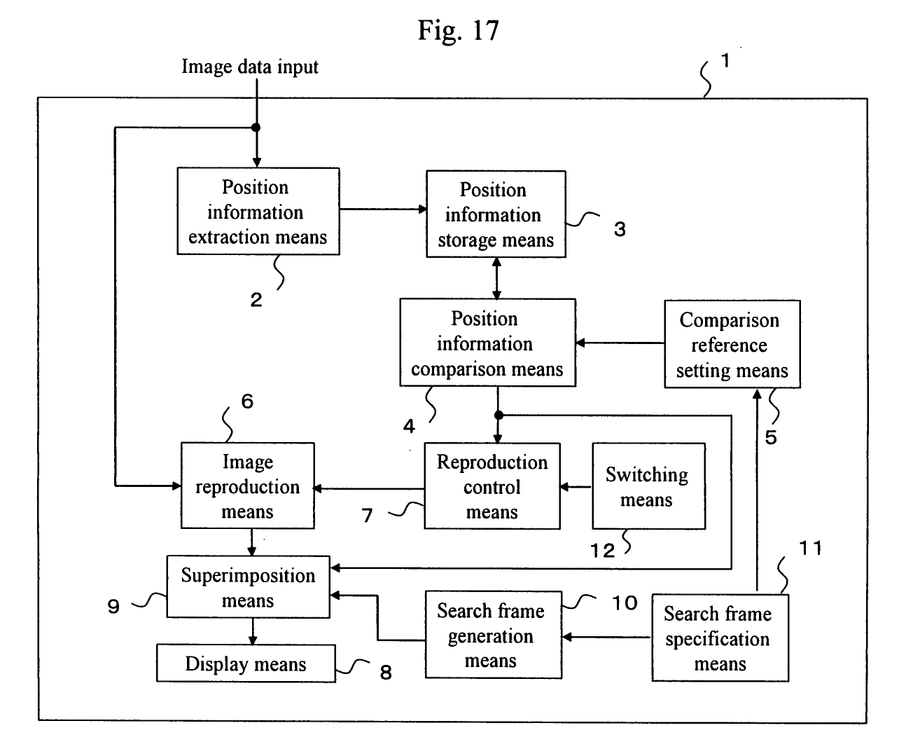

A second embodiment of the invention will be described with reference to FIGS. 17 to 22. Since the contents of the image processing device 1 are the same as those described in the first embodiment, the workings of the superimposition means 9 and switching means 12 will be described in this embodiment.

FIG. 17 shows an image processing device 1 in which the following are provided in the image processing device 1 of FIG. 12: the superimposition means 9 for displaying at least one of a numeral, a character, an icon and a symbol so as to be superimposed in the corresponding position within the display area when the image data corresponding to the comparison result is within the display area of the reproduction data; and the switching means 12 for instructing the reproduction control means 7 to reproduce the image data corresponding to the comparison result in order to switch the reproduction data.

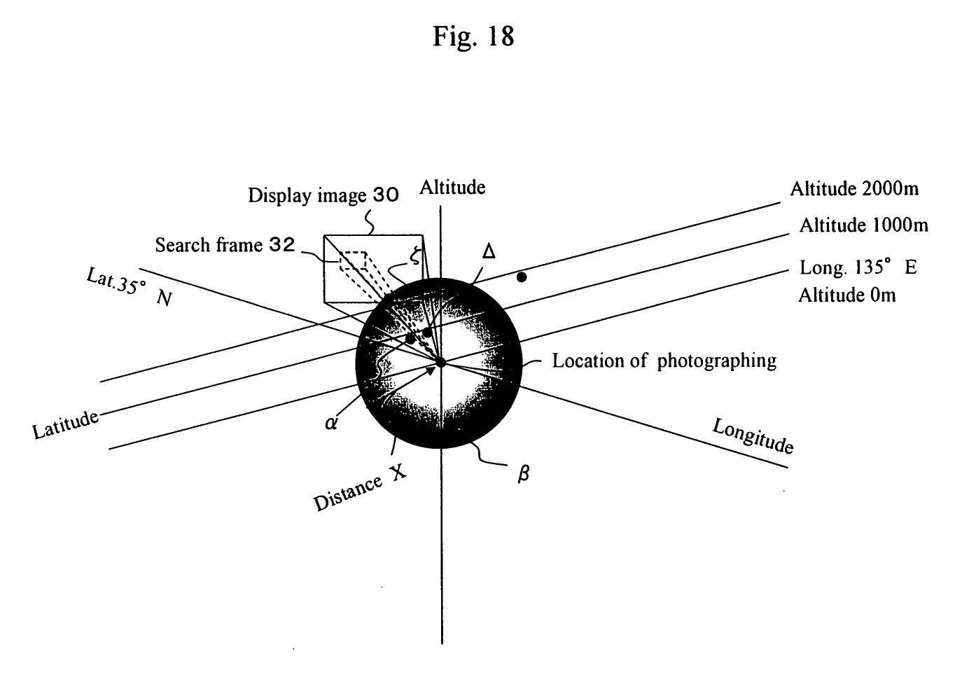

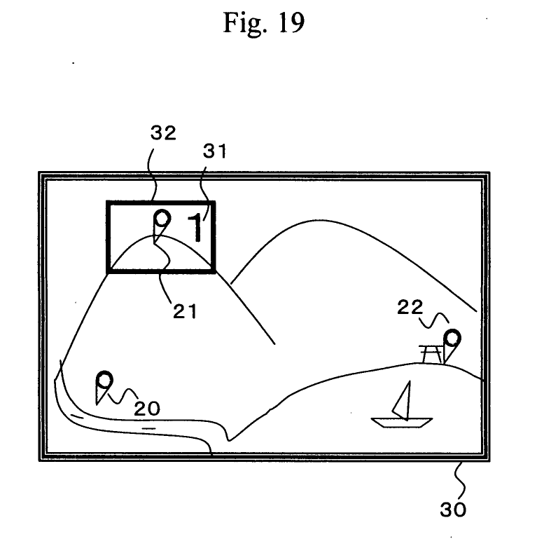

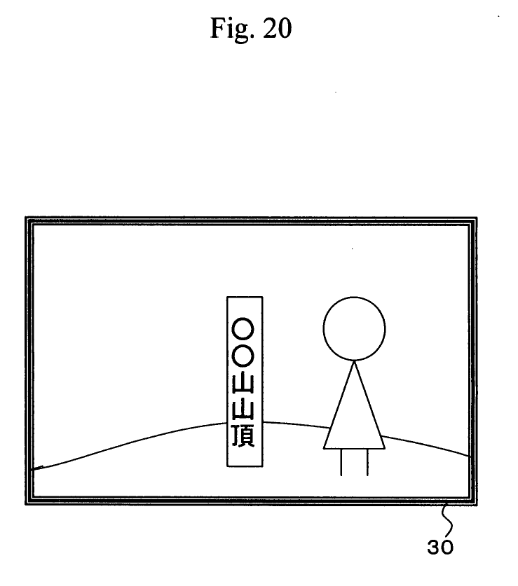

FIG. 18 is a conceptual view showing how the display image 30 and the search frame 32 are positioned with respect to the three-dimensional area represented by the latitude, the longitude and the altitude when a plurality of pieces of position information of image data of a latitude, a longitude and an altitude are recorded in the position information storage means 3. It is apparent from FIG. 18 that pieces of image data α, Δ and ζ are present within the area of the display image 30. FIG. 19 shows the display image 30, displayed by the display device 8, in which the comparison result 31 is superimposed on the reproduction data by the superimposition means 9 in the image processing device 1 of FIG. 17 when the position information of FIG. 18 is recorded in the position information storage means 3. An icon 20 in FIG. 19 corresponds to the image data α in FIG. 18, an icon 21 in FIG. 19 corresponds to the image data ζ in FIG. 18, and an icon 22 in FIG. 19 corresponds to the image data Δ in FIG. 18, and these are displayed as the corresponding icons so as to be superimposed in the corresponding positions within the display area by the superimposition means 9 since the pieces of image data α, Δ and ζ corresponding to the comparison result are within the display area of the reproduction data. When the icon 21 is selected by the search frame 32, the switching means 12 instructs the reproduction control means 7 to reproduce the image data ζ in order to switch the reproduction data. FIG. 20 shows the display image 30 where the image data ζ corresponding to the icon 21 in FIG. 19 is reproduced. As is apparent also from FIG. 19, the position of the icon 21 is near the summit of a mountain, FIG. 20 shows image data taken near the summit. In this manner, a link can be made to the image data related to the previous image.

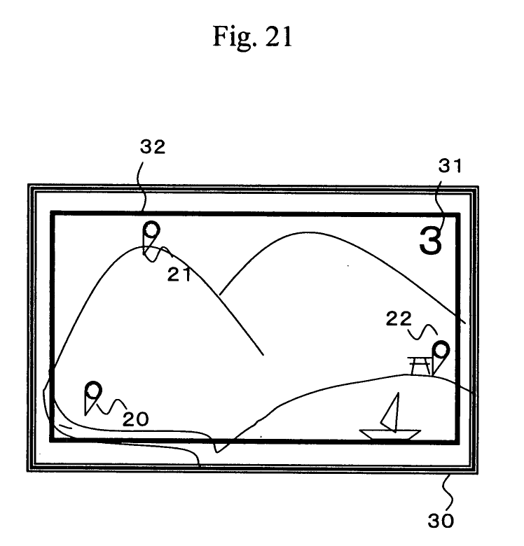

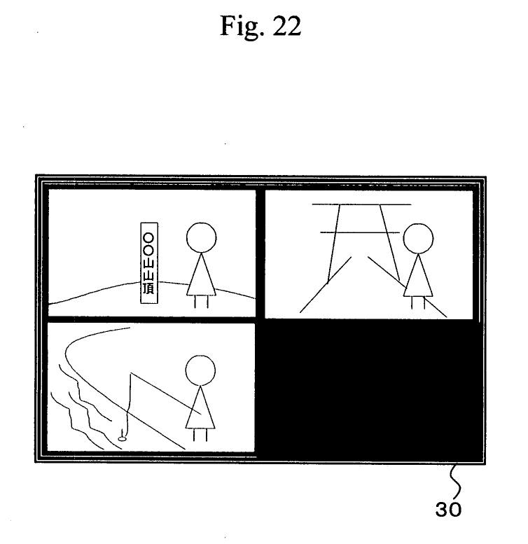

Next, an image processing device 1 will be shown in which image reproduction means 6 for simultaneously displaying one or more pieces of reproduction data corresponding to the comparison result when the reproduction data is switched by the switching means 12 is provided in the image processing device 1 of FIG. 17. FIG. 21 shows the display image 30 displayed when the search frame 32 of FIG. 19 is enlarged. By enlarging the search frame 32 in FIG. 19 like FIG. 21, the comparison result 31 becomes “3.” The display image 30 as a result of the switching means 12 instructing the reproduction control means 7 to reproduce the pieces of image data α, Δ and ζ in order to switch the reproduction data under this condition and the image reproduction means 6 reproducing the pieces of image data α, Δ and ζ is FIG. 22. Since the comparison result 31 is “3” in FIG. 19, three pieces of image data are reproduced and simultaneously displayed. In this way, the image processing device 1 can simultaneously display a plurality of pieces of image data corresponding to the comparison result. The number of pieces of image data displayed simultaneously can be changed by adjusting the size of the search frame as appropriate to thereby change the comparison result.

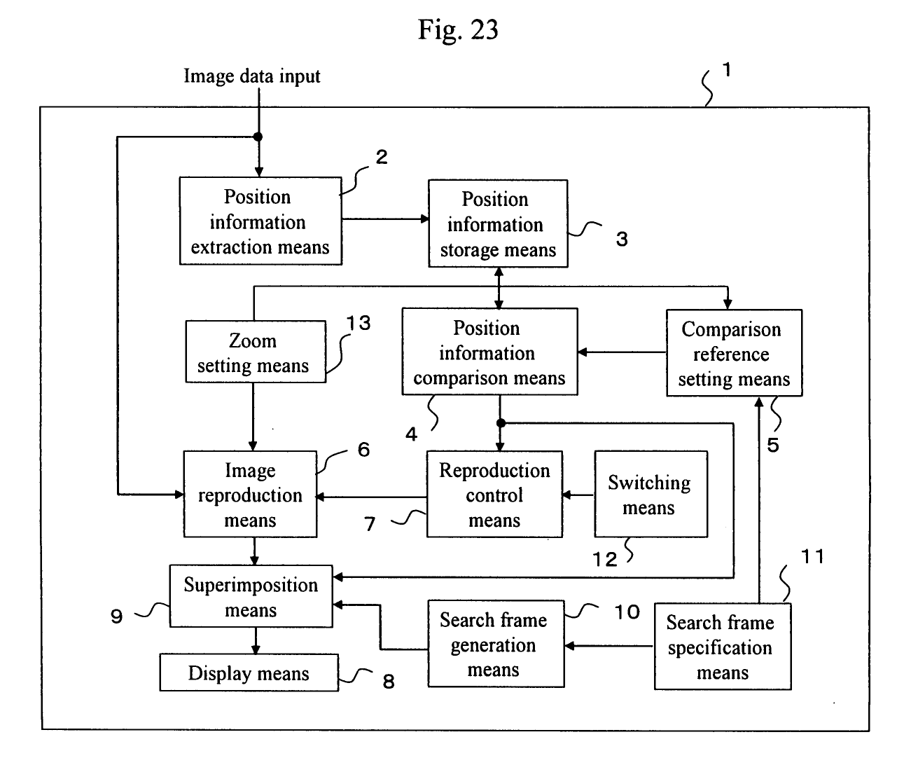

A third embodiment of the invention will be described with reference to FIGS. 23 to 27. Since the contents of the image processing device 1 are the same as those described in the first embodiment, the workings of the image reproduction means 6, the switching means 12 and zoom setting means 13 will be described in this embodiment.

FIG. 23 shows an image processing device 1 in which the following are provided in the image processing device 1 of FIG. 17: the zoom setting means 13 for specifying one or both of the zoom magnification and zoom position of the reproduction data; the image reproduction means 6 for zooming in and out the reproduction data in accordance with the zoom magnification and zoom position set by the zoom setting means 13; and the comparison reference setting means 5 for changing the comparison reference according to the zoom magnification and the zoom position.

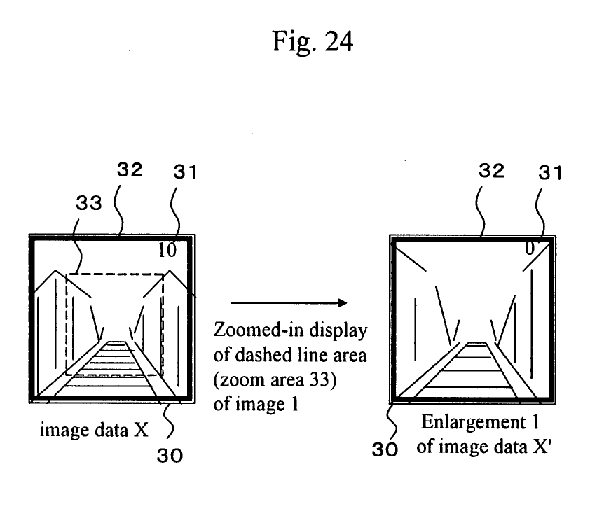

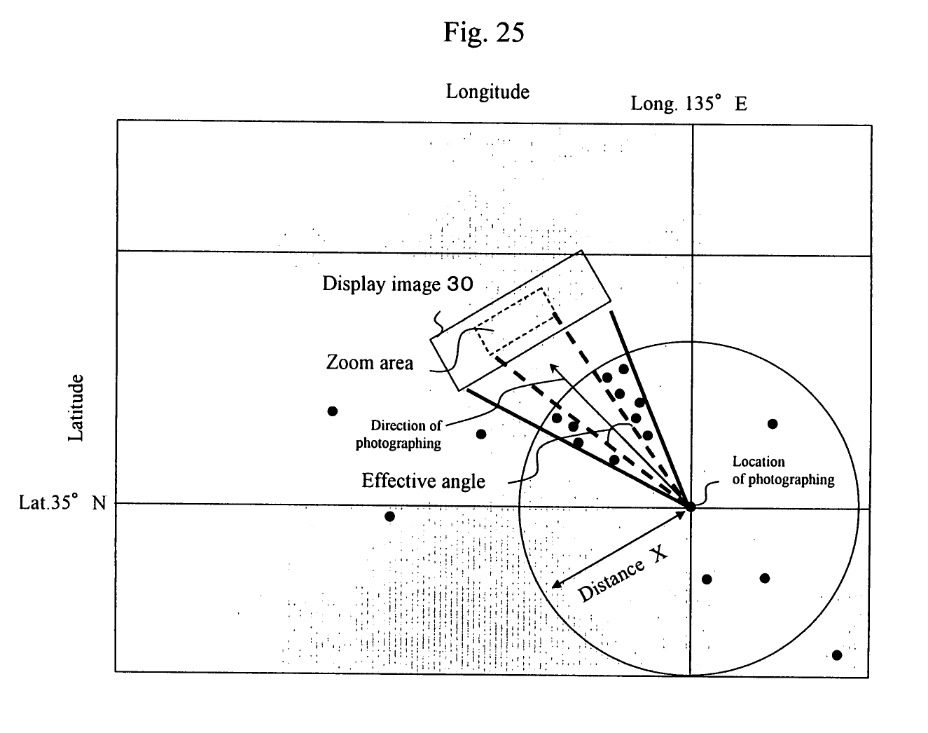

FIG. 24 shows the display image 30 of the image data X′ reproduced by the image processing device 1 of FIG. 23 and the display image 30 displayed by the display device 8 as a result of the image reproduction means 6 zooming a zoom area 33 indicated by the dashed line in the display image of the image data X′ in the image processing device 1 of FIG. 23. It is apparent that by performing zooming, the comparison reference of the comparison reference setting means 5 is changed and this changes the comparison result 31 from “10” of the image data X′ to “0” of an enlargement 1 of the image data X′. FIG. 25 is a conceptual view of the position information recorded in the position information storage means 3 for the image data X′ in FIG. 24 at this time. The dots in FIG. 25 represent the image data having the position information, and it is apparent that ten pieces of image data are present within the area of the display image 30 of the image data X′. However, turning to the zoom area 33, it is apparent that no image data is present therein. Consequently, in the enlargement 1 of the image data X′ of FIG. 24, since the zoom area 33 and the search frame 32 coincide with each other, the comparison result 31 is “0.”

In this way, the search frame 32 is changed according to the zoom area 33, and the comparison result 31 for the changed display image 30 can be obtained.

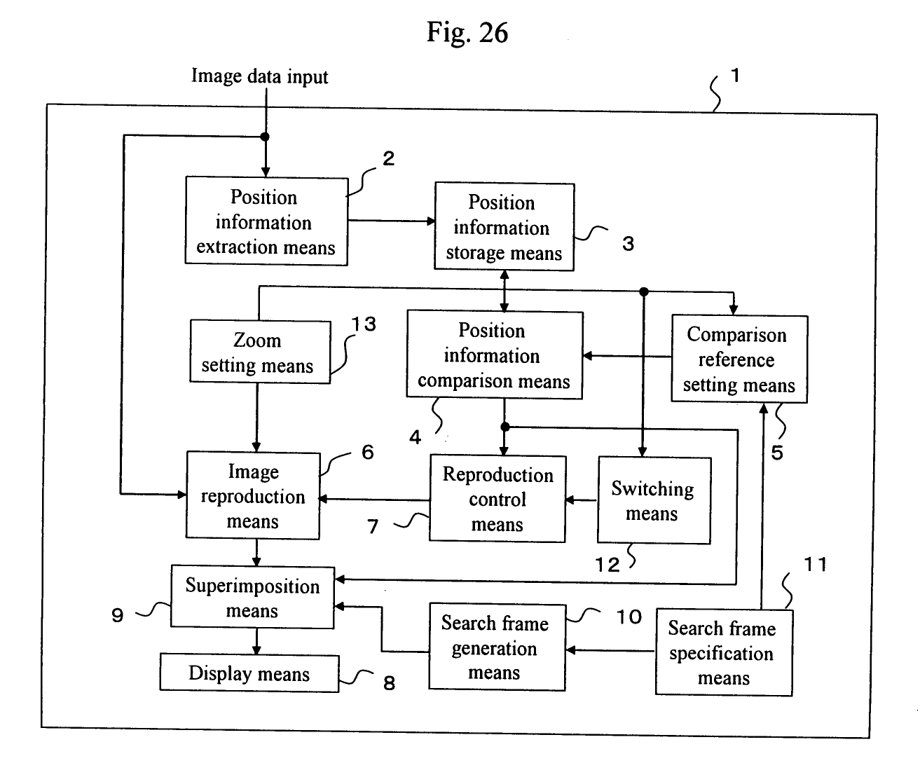

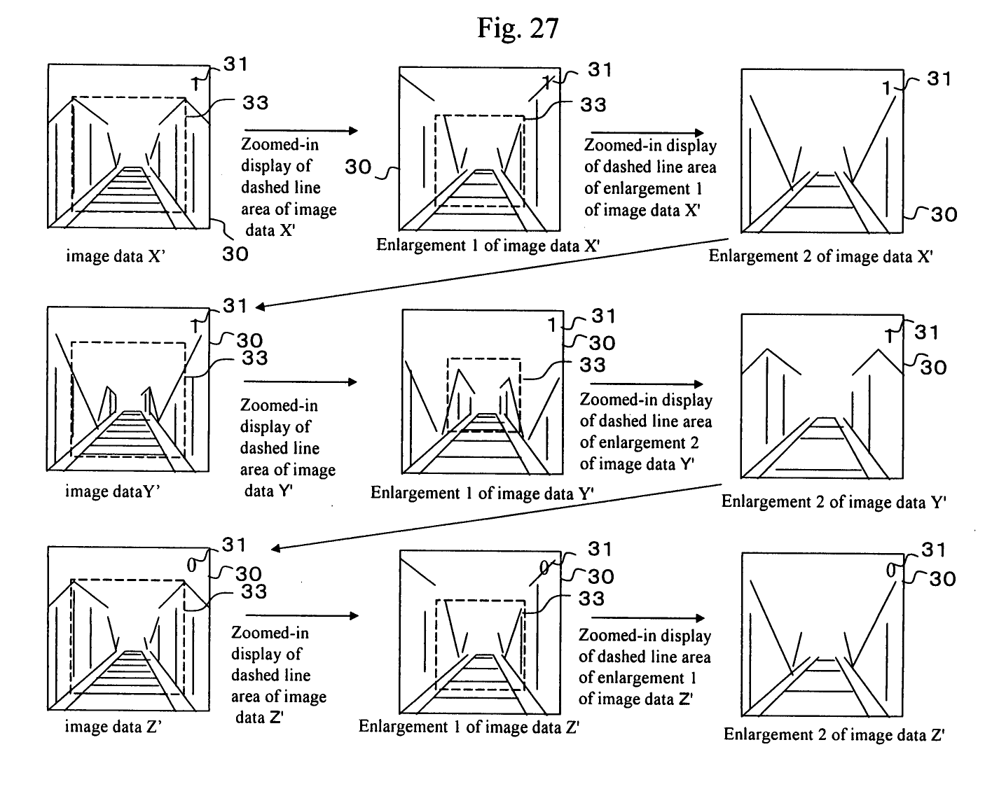

Next, FIG. 26 shows an image processing device 1 in which the switching means 12 for setting the zoom magnification or the upper limit of the zoom step representative of the degree of zooming and automatically instructing the reproduction control means 7 to reproduce the image data corresponding to the comparison result 31 when the zoom magnification or the zoom step reaches the set value is provided in the image processing device 1 of FIG. 23. FIG. 27 is a conceptual view showing that when zoom reproduction of the pieces of image data X′, Y′ and Z′ of FIG. 7 is performed by the image processing device 1 of FIG. 26, after zooming is performed to the set zoom step “2,” switching to the image corresponding to the comparison result is made. The image data X′ is reproduced by the image processing device 1 of FIG. 26, and the comparison result 31 is “1.” At this time, since “2” is set as the zoom step, the display image 30 is not switched. Then, the zoom area 33 of the image data X′ is zoomed by the image processing device 1, so that the display image 30 is switched to the enlargement 1 of the image data X′. Although the comparison reference is changed by zooming, since the pieces of image data X′, Y′ and Z′ are taken in the same direction, the comparison result 31 is “1” also at this time. At this time, the zoom step is “1” since zooming is performed once. Then, the zoom area 33 of the enlargement 1 of the image data X′ is zoomed by the image processing device 1, so that the display image 30 is switched to an enlargement 2 of the image data X′. Although the comparison reference is changed by zooming, the comparison result 31 is “1” also at this time. At this time, the zoom step is “2” since zooming is performed twice. Then, when zooming of the enlargement 2 of the image data X′ is tried, since the zoom step is already the set value “2,” the image processing device 1 reproduces the image data Y′ corresponding to the comparison result 31 of the enlargement 2 of the image data X′, and switching to the display image 30 of the image data Y′ is made. At this time, the zoom step is “0” since the image data Y′ is not zoomed. Thereafter, in a similar manner, the image data Y′ is enlarged twice, and the display data 30 of the enlargement 2 of the image data Y′ is displayed on the display device 8. Then, when zooming is tried, since the zoom step is already the set value “2,” the image processing device 1 reproduces the image data Z′, and switching to the display image 30 of the image data Z′ is made. At this time, the zoom step is “0” since the image data Z′ is not zoomed. Then, in a similar manner, the image data Z′ is enlarged twice, and the display data 30 of the enlargement 2 of the image data Z′ is displayed on the display means 8. At this time, since the comparison result 31 of the enlargement 2 of the image data Z′ is “0,” the image data to which switching is made is absent even if zooming is performed. Therefore, the enlargement 2 of the image data Z′ is zoomed, and the zoomed display data is displayed.

From the above, when part of the reproduction data is zoomed to confirm the details of the reproduction data, the data being reproduced can be viewed until the set zoom magnification or zoom step is reached, and when switching to the data corresponding to the comparison result is intended, by setting a zoom magnification higher than the set upper limit of the zoom magnification or repeating zooming beyond the set zoom step, switching to the image data corresponding to the comparison result can be made. Moreover, by successively making switching to the display image of the relevant image data by performing zooming, when the position information between pieces of image data is extremely close, still images can be displayed as if they were moving images.

The present invention is not limited to the above-described embodiments, but may be carried out as follows:

(1) While in the embodiments, an effect produced when the search frame is displayed is shown with the two-dimensional area for ease of explanation, the present invention may be carried out for three-dimensional areas. In that case, the height of the search frame affects the altitude of the comparison reference to change the effective angle with respect to the altitude.

(2) While in the embodiments, a frame-form search frame is used to select the image data corresponding to the comparison result, an icon search frame such as an arrow may be used to select the image data. Moreover, the color or shape of the icon corresponding to the selected image data may be changed so that it can be confirmed that the image data is selected.

(3) While in the embodiments, image data having a latitude and a longitude and image data having a latitude, a longitude and an altitude are separately described, a structure may be adopted such that even when any of the pieces of information is lacking, by setting the value of the lacking information to “0,” comparison can be performed for both two- and three-dimensional areas.

(4) While a case where zooming in is performed is described in the embodiments, zooming out may be performed.

### INDUSTRIAL APPLICABILITY

The image processing device according to the present invention produces effects such that when image data having position information is viewed, links can be followed between pieces of image data without the use of map data, and is effective, for example, as an image processing device used when information on real estates in the neighborhood is viewed.

1. An image processing device having image reproduction means for reproducing image data and outputting reproduction data, the image processing device comprising:
position information extraction means for extracting, from image data having position information, the position information;
position information storage means for storing the position information extracted by the position information extraction means;
position information comparison means for comparing the position information stored in the position information storage means with comparison reference;
comparison reference setting means for setting the comparison reference in the position information comparison means; and
reproduction control means for controlling the image reproduction means so as to reproduce image data corresponding to the position information in accordance with a result of the comparison by the position information comparison means.

2. An image processing device according to claim 1, wherein the comparison reference is a distance from a location represented by a latitude and longitude of the position information.

3. An image processing device according to claim 1, wherein the comparison reference is a distance from a location represented by a latitude, longitude and altitude of the position information.

4. An image processing device according to claim 1, wherein the comparison reference includes information on a direction in which the image data is taken.

5. An image processing device according to claim 1, wherein the comparison reference includes information having a predetermined angle with respect to a direction in which the image data is taken.

6. An image processing device according to claim 1, further comprising display means, including a liquid crystal monitor, a CRT or a PDP, for displaying the reproduction data outputted from the image reproduction means.

7. An image processing device according to claim 6, further comprising superimposition means for superimposing a result of the comparison outputted from the position information comparison means on the reproduction data as at least one of a numeral, a character, an icon and a symbol and outputting it to the display means.

8. An image processing device according to claim 7, further comprising:
search frame generation means for generating a search frame constituted by at least one of a frame and an icon for specifying an area where the position information is compared within a display area of the reproduction data; and
search frame specification means for specifying at least one of a size, color, shape and display position with respect to the reproduction data of the search frame,
wherein the superimposition means superimposes the search frame on the reproduction data, and outputs it to the display means, and
wherein the comparison reference setting means changes the comparison reference set in the position information comparison means in accordance with the size, position and shape of the search frame specified by the search frame specification means.

9. An image processing device according to claim 7, further comprising switching means for instructing the reproduction control means to reproduce selected image data in order to switch the reproduction data,
wherein when the image data corresponding to the result of the comparison is within a display area of the reproduction data, the superimposition means superimposes at least one of a numeral, a character, an icon and a symbol in a corresponding position within the display area, and causes the display means to display it.

10. An image processing device according to claim 6, wherein when the reproduction data is switched by the switching means, the image reproduction means simultaneously reproduces at least two pieces of reproduction data corresponding to the result of the comparison, and causes the display means to simultaneously display the at least two pieces of reproduction data.

11. An image processing device according to claim 6, further comprising zoom setting means for specifying at least one of a zoom magnification and zoom position of the reproduction data, wherein the image reproduction means zooms in or out the reproduction data in accordance with the zoom magnification or zoom position set in the zoom setting means, and
wherein the comparison reference setting means changes the comparison reference in accordance with the zoom magnification or the zoom position.

12. An image processing unit according to claim 11, wherein the switching means instructs the reproduction control means to reproduce the image data corresponding to the result of the comparison in accordance with the zoom magnification or a zoom step representative of a degree of zooming.

13. An image processing method for reproducing image data and outputting reproduction data, the image processing method comprising:
a position information extraction step of extracting, from image data having position information, the position information;
a position information storage step of storing the position information extracted at the position information extraction step;
a position information comparison step of comparing the position information stored at the position information storage step with comparison reference;
a comparison reference setting step of setting the comparison reference so as to be used in the position information comparison step; and
a reproduction control step of controlling image reproduction means for outputting the reproduction data, so as to reproduce image data corresponding to the position information in accordance with a result of the comparison at the position information comparison step.

14. An image processing method according to claim 13, wherein the comparison reference is a distance from a location represented by a latitude and longitude of the position information.

15. An image processing method according to claim 13, wherein the comparison reference is a distance from a location represented by a latitude, longitude and altitude of the position information.

16. An image processing method according to of claim 13, wherein the comparison reference includes information on a direction in which the image data is taken.

17. An image processing method according to of claim 13, wherein the comparison reference includes information having a predetermined angle with respect to a direction in which the image data is taken.

18. An image processing method according to claim 13, further comprising a display step of causing display means including a liquid crystal monitor, a CRT or a PDP to display the reproduction data outputted from the image reproduction means.

19. An image processing method according to claim 18, further comprising superimposition step of performing control so that a result of the comparison outputted at the position information comparison step is superimposed on the reproduction data as at least one of a numeral, a character, an icon and a symbol and displayed at the display step.

20. An image processing method according to claim 19, further comprising:
a search frame generation step of generating a search frame constituted by at least one of a frame and an icon for specifying an area where the position information is compared within a display area of the reproduction data; and
a search frame specification step of specifying at least one of a size, color, shape and display position with respect to the reproduction data of the search frame,
wherein control is performed so that the search frame is superimposed on the reproduction data at the superimposition step and displayed at the display step, and
wherein at the comparison reference setting step, the comparison reference set at the position information comparison step is changed in accordance with the size, position and shape of the search frame specified at the search frame specification step.

21. An image processing method according to claim 19, further comprising a switching step of providing an instruction to reproduce image data selected at the reproduction control step in order to switch the reproduction data,
wherein when the image data corresponding to the result of the comparison is within a display area of the reproduction data, at the superimposition step, at least one of a numeral, a character, an icon and a symbol is superimposed in a corresponding position within the display area and displayed by the display means.

22. An image processing method according to claim 18, wherein when the reproduction data is switched at the switching step, the image reproduction means simultaneously reproduces at least two pieces of reproduction data corresponding to the result of the comparison, and the at least two pieces of reproduction data are simultaneously displayed at the display step.

23. An image processing method according to claim 18, further comprising a zoom setting step of specifying at least one of a zoom magnification and zoom position of the reproduction data, wherein the image reproduction means zooms in or out the reproduction data in accordance with the zoom magnification or zoom position set at the zoom setting step, and
wherein at the comparison reference setting step, the comparison reference is changed in accordance with the zoom magnification or the zoom position.

24. An image processing method according to claim 23, wherein at the switching step, an instruction to reproduce the image data corresponding to the result of the comparison is provided for the reproduction control step in accordance with the zoom magnification or a zoom step representative of a degree of zooming.
